(19) United States
(12) Patent Application Publication
(10) Pub. No.: US 2016/0230660 A1
(43) Pub. Date: Aug. 11, 2016

(54) GAS TURBINE POWER GENERATOR WITH TWO-STAGE INLET AIR COOLING

(71) Applicant: KING SAUD UNIVERSITY, RIYADH (SA)

(72) Inventors: OBIDA MOHAMED ZEITOUN, RIYADH (SA); HANY ABDELRAHMAN ALANSARY, RIYADH (SA); ABDULLAH OTHMAN NUHAIT, RIYADH (SA)

(21) Appl. No.: 14/619,014

(22) Filed: Feb. 10, 2015

(51) Int. Cl. F02C 7/16; F02C 6/00; F02C 3/04; F02C 7/14

(52) U.S. Cl. CPC F02C 7/16; F02C 7/14; F02C 6/00; F02C 3/04; F05D 2260/213; F05D 2260/207; F05D 2220/32

(57) ABSTRACT

The gas turbine power generator with two-stage inlet air cooling is a gas turbine power plant for generating electrical power, where air fed into an inlet of a compressor thereof is cooled in a two-stage process. Initially, a heat exchanger receives ambient air and outputs cooled air. An evaporative cooler in fluid communication with the heat exchanger receives the cooled air at a first temperature and outputs cooled air at a second temperature lower than the first temperature. The cooled air at the second temperature is then delivered to a compressor, which is in fluid communication with a combustion chamber for combusting pressurized air with fuel. A gas turbine is in fluid communication with the combustion chamber for receiving heated combustion products therefrom to drive the gas turbine. An electrical generator is in communication with, and is driven by, the gas turbine for producing usable electrical power.

### BACKGROUND OF THE INVENTION

1. Field of the Invention

The present invention relates to power generation, and particularly to a gas turbine power plant utilizing two-stage cooled air at the input thereof.

2. Description of the Related Art

FIG. 2 illustrates a conventional gas turbine system 100. In such systems, ambient air enters a compressor 102, where the ambient air is compressed to provide pressurized air to a combustion chamber 104. Fuel is added to the compressed, pressurized air within combustion chamber 104 for combustion thereof, producing high temperature and high pressure combustion products (typically in the form of carbon dioxide, water vapor and air), which drive gas turbine 106. Gas turbine 106, driven by the high pressure and high temperature combustion products, drives a rotor 108 to partially power compressor 102, as well as driving generator 110 for producing usable electrical power. In such systems, it is common for approximately ⅔ of the power generated by gas turbine 106 to be drawn by compressor 102, with the remaining ⅓ of the power generated going to driving generator 110.

The total capacity and efficiency of such gas-powered turbine systems are highly variable, particularly in light of variations in the inlet air temperature and density. In a relatively harsh climate, such as in the Kingdom of Saudi Arabia (KSA), turbine capacities can fluctuate as much as 20% between summer (i.e., the time of lowest output) and winter conditions (i.e., the time of highest output), primarily due to relatively high temperature and low density ambient air in the summer months. It has been found that the power output of a gas turbine can fall from 84.4 MW at 15° C. to 69.0 MW at an ambient temperature of 45° C. Thus, by cooling the incoming air, the power output typically can be increased by more than 20%.

In order to cool air at the inlet of the compressor, the two primary conventional approaches are evaporative cooling and refrigeration. Refrigeration can use either chilled water coils (i.e., indirect cooling) or direct contact with sprayed, chilled water (i.e., direct cooling). Refrigeration is commonly provided by mechanical or absorption systems and, in some cases, using a thermal storage medium, such as ice or chilled water. For a medium sized combustion turbine (typically in the output range of 20-60 MW), exhaust heat is suitable in quantities and temperatures to power absorption refrigeration cycle systems.

Evaporative cooling systems are generally desirable to conventional refrigeration techniques, as described above, due to lower costs and overall efficiency. Using either a wetted medium or a water spray system, the cooling effects in evaporative cooling depend solely on the difference between dry bulb temperature (i.e., the temperature of air measured by a thermometer freely exposed to the air but shielded from radiation and moisture) and wet bulb temperature (i.e., the temperature a parcel of air would have if it were cooled to saturation—with 100% humidity—by the evaporation of water into it, with the latent heat being supplied by the parcel). Examples of evaporative coolers for gas turbine inlets are shown in U.S. Pat. No. 8,360,711 B2; U.S. Pat. No. 7,428,819 B2; U.S. Pat. No. 6,820,430 B1 and U.S. Pat. No. 6,422,019 B1, each of which is hereby incorporated by reference in its entirety.

A conventional type of evaporative cooling system is the cooling tower, such as exemplary cooling tower 200, shown in FIG. 3. Such cooling towers are well known in the art. Examples of such cooling towers are shown in U.S. Pat. No. 4,443,389; U.S. RE44,815 E and U.S. Pat. No. 6,615,585 B2, each of which is hereby incorporated by reference in its entirety. Returning to cooling tower 200 of FIG. 3, the cooling tower 200 includes a housing 211 having a cowl 212 at the upper end, in which is contained a blower 213 for causing movement of air in the direction indicated by the arrows 214 (outwardly, in this case), with air for the system being admitted through vents or louvers 216 in the lower end of housing 211. A closed circuit cooling system includes a bank of coils 217, inlet and outlet fittings 218 and 219, respectively, a pump 220 and a storage receptacle 221. The cooling tower 200 is associated with a device 222 to be cooled as described in greater detail below.

The pump 220 draws a cooling liquid or medium from the device 222 and forces it through helical coils 217. The coils 217 have distributed thereover a cooling fluid, such as water, which is pumped by a pump 224 from a storage reservoir 226 in the lower end of cooling tower housing 211, through a filter 227 to a nozzle 228. A mounting bracket 254 carries an impeller of an impulse turbine 229, which is coaxially mounted on shaft 230 of blower 213 so that the fluid ejected from nozzle 228 impacts on the blades of impeller 229 to rotate blower 213. A float 231 controls a valve 232 for admitting make up water to replenish reservoir 226.

Air, in this case, is drawn through the louvers 216 and upwardly through the cooling coils 217 in counter flow direction with respect to the flow of cooling water through a packing element, which removes the water from the air stream and the air exits through cowling 212 to the atmosphere. The coils 217 are designed to enhance the heat transfer between the cooling medium on the exterior surfaces of the coil 217 (a mixture of air and water) and the heat exchange medium flowing in the closed circuit to the device 222.

In addition to conventional refrigeration and evaporative cooling, mechanical vapor compression refrigeration can also be used for cooling inlet air temperatures for the compressor. Such conventional mechanical vapor compression refrigeration is accomplished by passing relatively hot ambient air over a cooling coil which is fed with chilled water (or brine) coming from a chiller. A main advantage of such systems is that air can be cooled to temperatures well below the wet bulb temperature. Additionally, such refrigeration systems can potentially dehumidify the incoming air stream, thus minimizing the risk of damage to the compressor blades. However, mechanical chilling is typically characterized by a relatively high initial cost of usage, as well as relatively high power consumption in the various components of the system, such as the chiller, particularly when compared against evaporative cooling, which has a relatively low power consumption. Further, mechanical chilling can cause an appreciable and permanent pressure drop upstream of the compressor inlet which, in turn, can cause a relatively slight drop in power augmentation.

Hybrid turbine inlet cooling systems combining the benefits of evaporative cooling with those of mechanical vapor compression refrigeration are known. One such system is based on a two-step cooling process in which air is first cooled to an intermediate temperature by mechanical vapor compression and then further cooled by evaporative cooling. When compared to evaporative cooling, the two-stage system can have the advantage of achieving significantly lower air dry bulb temperatures, due to the air at the start of the evaporative cooling stage already having a wet bulb temperature well below that of the hot ambient air dry bulb temperatures. Further, such hybrid systems typically require significantly smaller amounts of make-up water compared to conventional evaporative cooling systems since the amount of water that needs to be added initially is significantly lower. When compared to mechanical vapor compression, the two-stage system cools the air to an intermediate temperature, making the required chilling/refrigerating capacity significantly lower. Thus, the required chillers can have smaller comparative capacities and consume relatively less power.

Given the benefits of the two-stage cooling cycle, as well as the advantages of evaporative cooling when compared against mechanical vapor compression refrigeration, it would be desirable to provide a two-stage evaporative cooling method for turbine inlet cooling to reduce the inlet air dry bulb temperature below the inlet air wet bulb temperature. Thus, a gas turbine power generator with two-stage inlet air cooling addressing the aforementioned problems is desired.

### SUMMARY OF THE INVENTION

The gas turbine power generator with two-stage inlet air cooling is a gas turbine power plant for generating electrical power, where air fed into an inlet of a compressor thereof is cooled in a two-stage process. The gas turbine power generator with two-stage inlet air cooling includes a heat exchange cooler, the heat exchange cooler including a heat exchanger and as associated cooling tower to cool a cooling medium flowing through the heat exchanger, the heat exchanger adapted to receive ambient air and adapted to output cooled air at a first temperature lower than a temperature of the ambient air. An evaporative cooler for evaporative cooling is in fluid communication with the heat exchanger for receiving the cooled air at the first temperature and for evaporative cooling and outputting the evaporative cooled air at a second temperature lower than the first temperature. The cooled air at the second temperature is then delivered to a compressor, which is in fluid communication with a combustion chamber for combusting pressurized air output from the compressor with fuel. A gas turbine is in fluid communication with the combustion chamber for receiving heated combustion products therefrom, such that the heated combustion products drive the gas turbine. An electrical generator is in communication with, and is driven by, the gas turbine for producing usable electrical power.

These and other features of the present invention will become readily apparent upon further review of the following specification and drawings.

### BRIEF DESCRIPTION OF THE DRAWINGS

FIG. 1 diagrammatically illustrates a gas turbine power generator with two-stage inlet air cooling according to the present invention.

FIG. 2 diagrammatically illustrates a conventional gas turbine system.

FIG. 3 diagrammatically illustrates a conventional cooling tower.

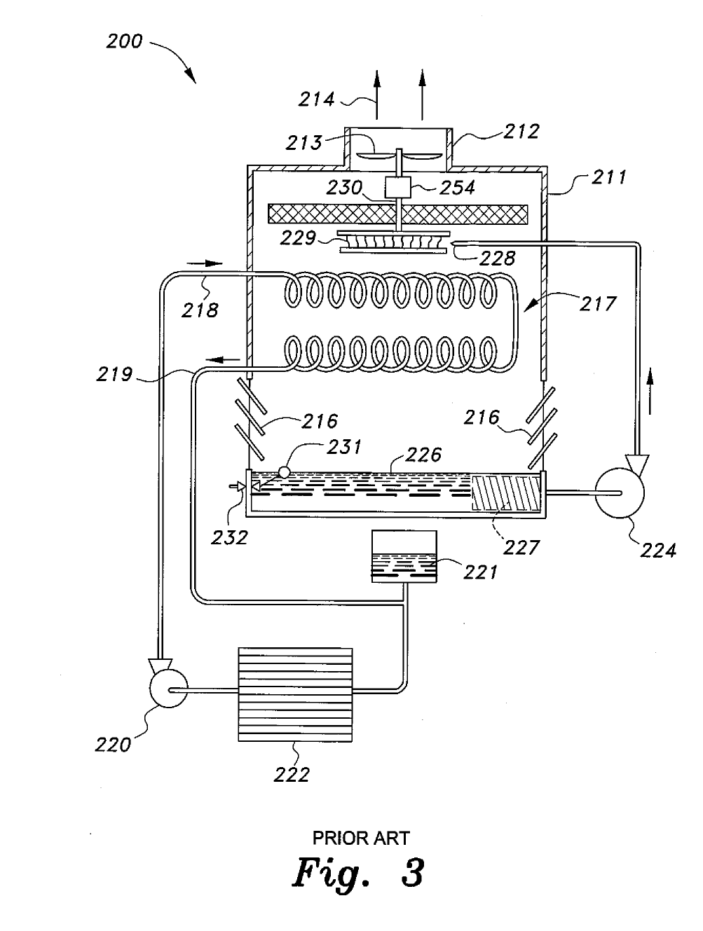

FIG. 4 is a graph illustrating a comparison of a humidity ratio of air versus temperature at differing stages in an embodiment of a process for two-stage evaporative cooling for gas turbine inlet cooling in a gas turbine power generator with two-stage inlet air cooling according to the present invention.

Unless otherwise indicated, similar reference characters denote corresponding features consistently throughout the attached drawings.

### DETAILED DESCRIPTION OF THE PREFERRED EMBODIMENTS

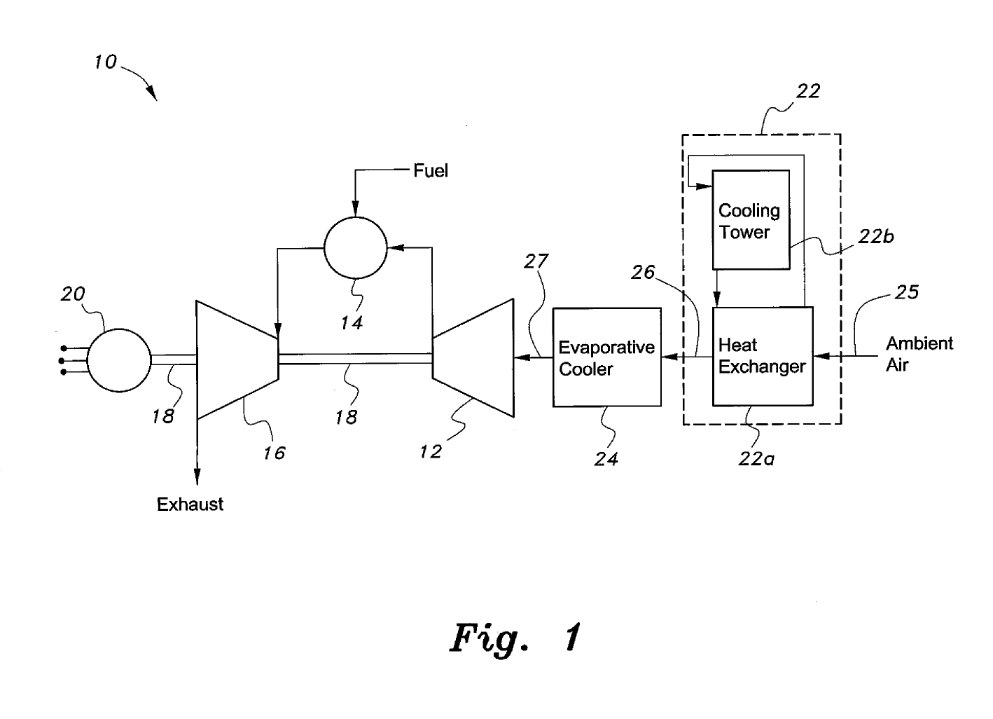

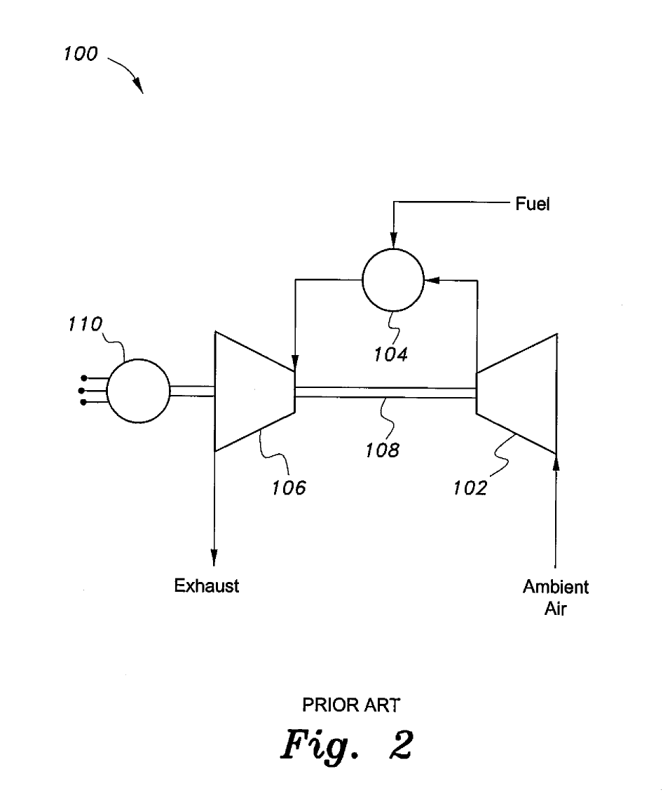

Embodiments of a gas turbine power generator with a two-stage inlet air cooling system, such as a gas turbine power generator with a two-stage inlet air cooling system 10, the “system 10”, is a gas turbine power plant for generating electrical power, where air fed into an inlet of a compressor 12 thereof is cooled in a two-stage process. As shown in FIG. 1, as to the gas turbine power generator portion of the system 10, the gas turbine power generator portion is similar to the system 100 of FIG. 2. In this regard, the system 10 includes the compressor 12 for compressing air fed thereto to provide pressurized air to a combustion chamber 14. Fuel is added to the compressed, pressurized air within the combustion chamber 14 for combustion thereof, producing high temperature and high pressure combustion products (typically including such combustion products in the form of carbon dioxide, water vapor and air), which drive a gas turbine 16.

The gas turbine 16, driven by the high pressure and high temperature combustion products, drive a rotor 18 to partially power the compressor 12, as well as driving a generator 20 for producing usable electrical power. As opposed to a conventional gas turbine power plant, such as the system 100 of FIG. 2, ambient air entering the system 10, on a flow path 25, is first cooled in a first stage by a heat exchange cooler 22 including a heat exchanger 22a and an associated cooling tower 22b. In the first stage heat exchange cooler 22, the heat exchanger 22a can be integrated with the cooling tower 22b, or can be separate therefrom and in fluid communication therewith, for example.

The heat exchanger 22a cools the ambient air by a cooling medium flowing through the heat exchanger 22a. The cooling medium in the heat exchanger 22a is circulated to the cooling tower 22b to be cooled by the cooling tower 22b. The heat exchanger 22a is adapted to receive the ambient air on the flow path 25 and adapted to output cooled air at a first temperature lower than a temperature of the ambient air entering the heat exchanger 22a. The heat exchanger 22a and the cooling tower 22b can be any suitable type of heat exchanger and cooling tower, such as those described above, as can depend on the use or application, and should not be construed in a limiting sense.

The first stage cooled air is then delivered from the heat exchanger 22a on a flow path 26 to an evaporative cooler 24 for a second stage of evaporative cooling. The evaporative cooler 24 is in fluid communication with the heat exchanger 22a for receiving the cooled air at the first temperature and outputting the evaporative cooled air at a second temperature lower than the first temperature. The evaporative cooled air at the second temperature is then delivered on a flow path 27 from the evaporative cooler 24 to the compressor 12 as an input thereto.

The compressor 12 is in fluid communication with the combustion chamber 14 for combusting pressurized air output from the compressor 12 with fuel. The evaporative cooler 24 can be any suitable type of evaporative cooler, such as those described above, as can depend on the use or application, and should not be construed in a limiting sense. The gas turbine 16 is in fluid communication with the combustion chamber 14 for receiving heated combustion products therefrom, and the heated combustion products drive the gas turbine 16. The gas turbine 16, driven by the high pressure and high temperature combustion products, drive the rotor 18 to partially power the compressor 12, as well as driving a generator 20 for producing or generating usable electrical power, as described.

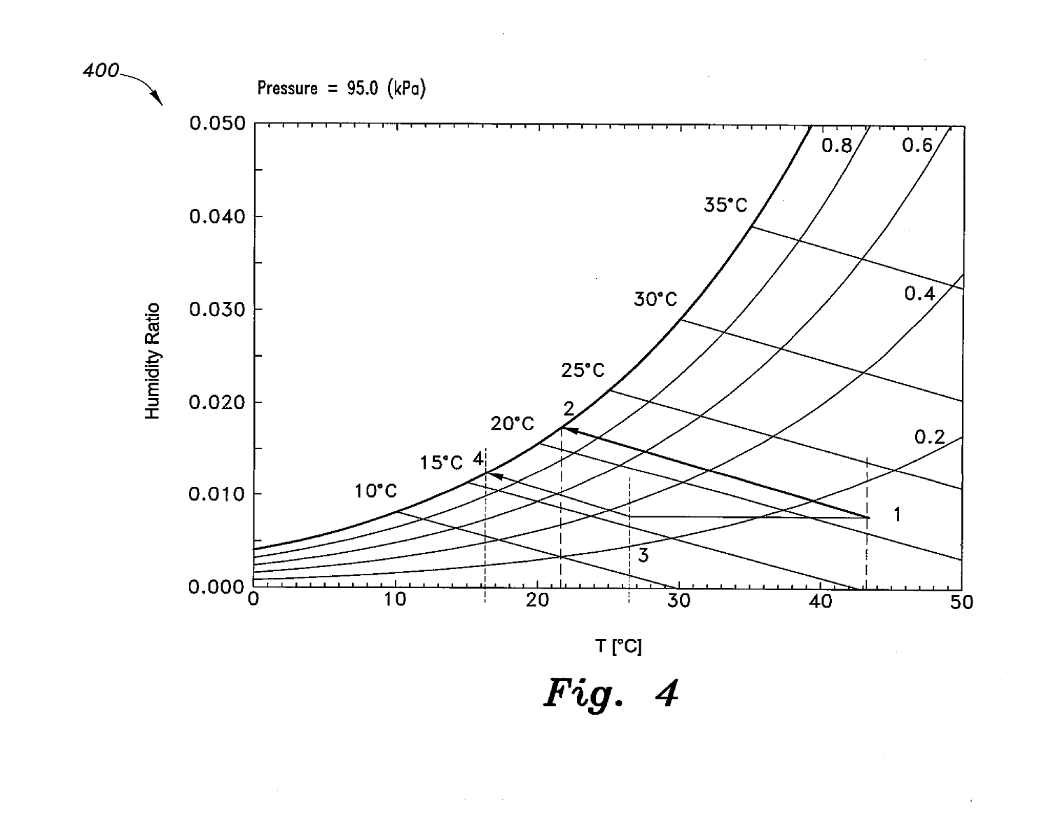

FIG. 4 illustrates in a graph 400 an effectiveness of embodiments of the two-stage evaporative cooling by embodiments of the system 10. In FIG. 4, the graph 400 compares temperature (T) in degrees centigrade (° C.) versus humidity ratio at a pressure 95.0 kilopascals (kPa). In the graph 400, temperature 1 is the temperature of the initial ambient air which enters the heat exchanger 22a of the heat exchange cooler 22, temperature 2 is the ambient air wet bulb temperature, temperature 3 is the temperature of the first stage cooled air; i.e., the air output from heat exchanger 22a and being input to the evaporative cooler 24, and temperature 4 is the two-stage cooled air output from evaporative cooler 24 and being input to compressor 12.

Additionally, Table 1 below shows the results of using an embodiment of the two-stage cooling system 10 with a conventional gas turbine power plant in Riyadh, Saudi Arabia, during the summer months of May through September. Table 1 also includes the weather conditions and assumes a 100% evaporative cooling effectiveness, a 5° C. temperature rise of water passing through the heat exchanger 22a of the heat exchange cooler 22, a water flow rate in the cooling tower 22b per kilowatt (kW) cooling of the heat exchanger 22a of between 36×10⁻⁶ meters³/second (m³/s) and 54×10⁻⁶ (m³/s), and air exiting the cooling coil at a temperature of 3° C. higher than that of the cooling tower 22b water exit temperature Tₑₜ.

TABLE 1
Results of Two-Stage Cooling for a Gas Turbine Power Plant

| | Ambient Conditions | | | | | | | | | | ΔW/ |
|---|---|---|---|---|---|---|---|---|---|---|---|
| | Pₐₜₘ | T_{d} | T_{wet} | RH | \dot{m}_{w} | T₄ | T_{ct} | Wᵢₛₒ | W_{with} | W_{without} | W_{without} |
| Month | kPa | ° C. | ° C. | % | Ton/hr | ° C. | ° C. | MW | kW | kW | % |
| May | 94.2 | 38.65 | 21.45 | 22 | 12.87 | 18.29 | 24.98 | 84.4 | 82248 | 71735 | 14.7 |
| June | 94.2 | 41.45 | 20.35 | 14 | 16.17 | 15.85 | 24.22 | 84.4 | 83541 | 70312 | 18.8 |
| July | 94.2 | 42.75 | 21.55 | 15 | 16.28 | 17.11 | 25.05 | 84.4 | 82872 | 69624 | 19.0 |
| August | 94.2 | 42.45 | 20.95 | 14 | 16.53 | 16.36 | 24.64 | 84.4 | 83270 | 69788 | 19.3 |
| September | 94.2 | 40.05 | 21.05 | 18 | 14.39 | 17.30 | 24.71 | 84.4 | 82774 | 71021 | 16.5 |

As can be seen in Table 1, the output power of the gas turbine without using the two-stage cooling system 10, W_{without}, falls down 15%-20% below the ISO power rating, Wᵢₛₒ, for example. However, using the two-stage cooling system 10 and embodiments of the two stage cooling process can reduce for the cooled air the inlet air dry bulb temperatures to temperatures below the ambient wet bulb temperatures. Further, output power of the gas turbine power plant can be increased by 14.7%-19.3%, for example In Table 1, Pₐₜₘ is atmospheric pressure, T_{d} is the dry bulb temperature, T_{wet} is the ambient wet bulb temperature, RH is relative humidity, rh_{w} is the rate of make-up water (in tons/hour), T₄ is the temperature of air being input to the compressor 12 (i.e., the twice-cooled air), W_{with} is the power output of the gas turbine using embodiments of the two-stage cooling system 10 and embodiments of the two-stage cooling process, and ΔW is the difference of W_{with}−W_{without}.

Also, embodiments of the two-stage cooling system can substantially reduce or substantially eliminate a need for use of mechanical vapor compression, which typically consumes relatively more power that evaporative cooling. Also, use of the evaporative cooler and evaporative cooling process can substantially reduce or can eliminate a need for use of environmentally hazardous refrigerants from the turbine inlet cooling system, thereby enhancing environmental friendliness of the cooling system.

It is to be understood that the present invention is not limited to the embodiments described above, but encompasses any and all embodiments within the scope of the following claims.

1. A gas turbine power generator with two-stage inlet air cooling, comprising:
a heat exchange cooler for receiving ambient air and outputting cooled air at a first temperature lower than a temperature of the ambient air;
the heat exchange cooler consisting of a heat exchanger, a cooling tower, a circuit loop, and a cooling medium, the cooling medium disposed in the circuit loop for looping between the heat exchanger and the cooling tower;
wherein the heat exchanger cools the ambient air by the cooling medium in the circuit loop flowing through the heat exchanger,
wherein the cooling tower cools the cooling medium in the circuit loop within the heat exchange cooler used to cool the ambient air to the first temperature within the heat exchanger, and
the cooling medium in the circuit loop within the heat exchange cooler circulates through the cooling tower to be re-cooled in the cooling tower and returned to the heat exchanger;
an evaporative cooler in fluid communication with the heat exchange cooler for receiving the cooled air at the first temperature from the heat exchanger and for evaporative cooling and outputting the evaporative cooled air at a second temperature lower than the first temperature;
a compressor in fluid communication with the evaporative cooler for receiving the cooled air at the second temperature;
a combustion chamber in fluid communication with the compressor for combusting pressurized air output from the compressor with a fuel;
a gas turbine in fluid communication with the combustion chamber for receiving heated combustion products therefrom, the heated combustion products driving the gas turbine; and
an electrical generator in communication with the gas turbine for generating electrical power.

2. (canceled)

3. The gas turbine power generator with two-stage inlet air cooling as recited in claim 1, wherein an inlet air dry bulb temperature for the cooled air is below an ambient wet bulb temperature for the cooled air.

4-7. (canceled)

8. A cooling system in combination with a gas turbine power generator, the combination comprising:
a two-stage inlet cooling system; and
a gas turbine power generator;
the two-stage inlet cooling system consisting of:
a heat exchange cooler for a first stage of cooling ambient air, the heat exchange cooler including:
a heat exchange cooler to cool the ambient air by a cooling medium flowing through the heat exchange cooler to output a first stage cooled air at a first temperature lower than an initial temperature of the ambient air, and
a cooling tower associated with the heat exchange cooler, the cooling tower being in fluid communication with the cooling medium from the heat exchange cooler and the cooling medium being circulated to the cooling tower to cool the cooling medium from the heat exchange cooler; and
an evaporative cooler for a second stage of cooling the first stage cooled air, the evaporative cooler being in fluid communication with the heat exchange cooler to receive the first stage cooled air and to cool by evaporative cooling the first stage cooled air at the first temperature to a second stage cooled air at a second temperature, the second temperature is lower than the first temperature;
wherein the evaporative cooler being adapted to output the second stage cooled air at the second temperature to the gas turbine power generator.

9. The combination as recited in claim 8, wherein an inlet air dry bulb temperature for the cooled air is below an ambient wet bulb temperature for the cooled air.

10. The combination as recited in claim 8, wherein the gas turbine power generator comprises:
a compressor in fluid communication with the evaporative cooler for receiving the cooled air at the second temperature;
a combustion chamber in fluid communication with the compressor for combusting pressurized air output from the compressor with a fuel;
a gas turbine in fluid communication with the combustion chamber for receiving heated combustion products therefrom, the heated combustion products driving the gas turbine; and
an electrical generator in communication with, and driven by, the gas turbine to generate electrical power.

11. The combination as recited in claim 10, wherein an inlet air dry bulb temperature for the cooled air is below an ambient wet bulb temperature for the cooled air.

12-17. (canceled)

18. A power generator, comprising:
a first air cooler for receiving ambient air at an initial temperature and outputting air at a first temperature;
wherein the first temperature is lower than the initial temperature;
the first air cooler consists of:
a heat exchanger;
a cooling tower operatively coupled to the heat exchanger; and
a cooling medium circulated between the heat exchanger and the cooling tower;
wherein the cooling medium cools the ambient air at the initial temperature by absorbing heat therefrom in the heat exchanger, and the cooling medium expels the absorbed heat in cooling tower while circulating between the cooling tower and the heat exchanger;
a second air cooler in fluid communication with the first air cooler for receiving at an input the ambient air at the first temperature and providing at an output the ambient air at a second temperature;
wherein the second temperature is less than the first temperature;
the second air cooler consists of:
an evaporative cooler for providing an evaporative cooling function on the ambient air at the first temperature, and outputting the ambient air at the second temperature;
a compressor coupled with the second air cooler for receiving the ambient air at the second temperature, and compressing the ambient air into pressurized air at an output;
a combustion chamber in fluid communication at the output of the compressor for combusting the pressurized air with a fuel supply, outputting combustion gas products at an output thereof;
a gas turbine in fluid communication with the output of the combustion chamber for receiving combustion gas products therefrom, the combustion gas products operatively driving the gas turbine;
means coupled to the gas turbine for driving the compressor; and
an electrical generator coupled to gas turbine for generating electrical power.

19. The power generator as recited in claim 18, wherein
an inlet air dry bulb temperature for the ambient air at the second temperature is below an ambient wet bulb temperature for the ambient air at the second temperature.

20. The gas turbine power generator with two-stage inlet air cooling as recited in claim 1, further comprising:
a rotor mechanically linking the gas turbine and the compressor;
wherein the gas turbine drives the rotor, and the rotor drives the compressor.
